(19) United States
(12) Patent Application Publication
(10) Pub. No.: US 2004/0148812 A1
(43) Pub. Date: Aug. 5, 2004

(54) Rock and root puller

(76) Inventor: Normand L'Ecuyer, Hemmingford (CA)

Correspondence Address: INVENTARIUM, suite 1607, 4050 Rosemont blvd, Montreal, QC, H1X 1M4, CA

(21) Appl. No.: 10/745,711

(22) Filed: Dec. 26, 2003

Related U.S. Application Data
(60) Provisional application No. 60/436,584, filed on Dec. 27, 2002.

(51) Int. Cl. A01B 13/00

(52) U.S. Cl. 37/302

(57) ABSTRACT

A rock and root puller connected to a three point hitch assembly and used for extracting rocks, stumps roots and other impediments at or below ground level having a fixed frame assembly and an articualted frame assembly both bivotally connected together and the articulated frame assembly moving along a vertical plane relative to the fixed frame assembly when actuated by a hydraulic piston; a set of braces bracing both ends of the piston and forming a piston frame assembly; a three point hitch brace securing the three point hitch assembly; a straight edge situated underneath the articulated frame assembly.

This application claims priority based on provisional application 60/436,584 filed Dec. 27, 2003

### BACKGROUND OF THE INVENTION

1. Field of the Invention

This invention relates generally to farming equipment but more particularly to an apparatus aimed at pulling rocks, roots and stumps from fields.

2. Background

The bane of many farmers is to remove rocks that interfere with the growing of their crops. Indeed, the underground is constantly shifting especially in northern climes where the freezing and thawing of the soil can move rocks, that used to be buried deep, up onto the surface or close enough to be a nuisance. This can wreak havoc to an otherwise perfect field. Also, if a farmer wants to expand his field into a previously wooded area, he has to remove tree stumps as well as roots that, like rocks, can shift and move upwards over time.

Over the years, a number of tractor accessories have been developed to handle this situation. The accessories generally are connected to the rear of a farm tractor by way of a standard three point hitch. They are also generally comprised of a hydraulic piston to move part of the accessory, usually a hook or hooks assembly used in grappling a rock or stump.

Other similar implements for use in gemeral plowing are also very similar in their construction since after all, there is some degree of standardization in tractors and three point hitches, also, farming does involve working the soil and therefore a lot of basic components are common knowledge, even obvious to those skilled in the art.

However, the prior art does not show inventions that could be combined to provide all of the advantages of this present invention without requiring unobvious changes or modifications. There is therefore a need for a practical rock and root puller that is sturdy, practical, easy to mount and dismount onto a farm tractor three point hitch and easy to operate.

### SUMMARY OF THE INVENTION

A first object of the present invention is to have a piston that is on top of the machine in order to be clear of the ground and all encumberances and impediments at or below ground level.

A second object is to have a blade hook with a small claw to avoid any entanglement. A final object is to provide a pair of extendable stands to easily align the rock and root puller with the three point hitch of the tractor.

In order to do so, the invention has a reinforced straight edge terminating with a claw which acts as a hook to grapple impediments to be removed and a pair of exdendable stands so that the rock and root puller can stand upright on its own and a piston that is situated at the uppermost part of the invention so that it is easily accessible and visible while being clear off the ground.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

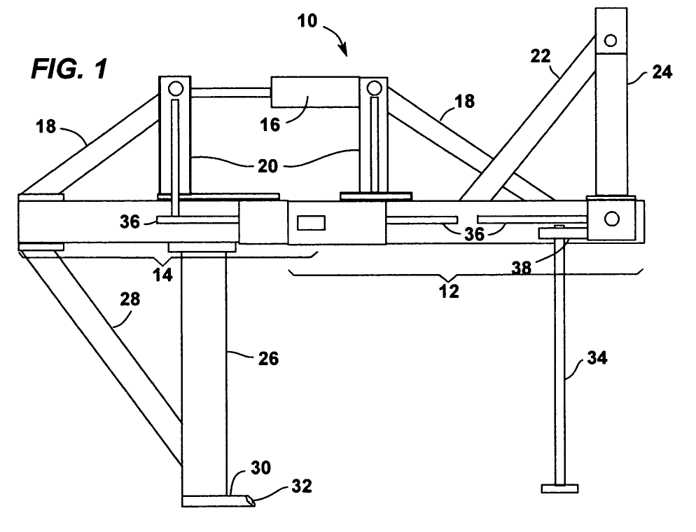

FIG. 1 Side elevation of the invention.

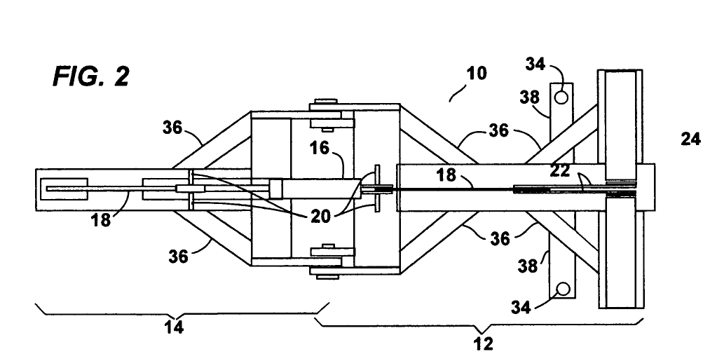

FIG. 2 Top elevation of the invention.

### DETAILED DESCRIPTION OF THE PREFERRED EMBODIMENT

A rock and root puller (10) has a fixed frame assembly (12) and an articulated frame assembly (14) both pivotally connected together. The articulated frame assembly (14) moves along a vertical plane from the fixed frame assembly (12) when actuated by a hydraulic piston (16). A set of braces (18) brace both ends of the piston (16) into a piston frame assembly (20). A two bladed three point hitch brace (22) secures the three point hitch assembly (24).

Underneath the articulated frame assembly (14) is a straight edge (26) braced by a straight edge brace (28) and said straight edge (26) terminates at its lowest end by a claw (30) which has a beveled tip (32). The straight edge (26) configuration allows for easy digging into soil in order to reach in and pin a rock, a stump or a root and dislodge it.

Underneath the fixed frame assembly (12) are a pair of stands (34) which are set proximal to the three point hitch assembly (24) and act as support to the rock and root puller (10) when it is not in use, and also makes it easy for mounting and dismounting onto a tractor's three point hitch. Obviously, hydraulic lines (not shown) feed the piston (16) from a compressed oil source normally found on a farm tractor.

A system of reinforcement braces (36), more clearly seen in FIG. 2 add overall strength to the rock and root puller (10) and a pair of stand holders (38) secure the stands (34) onto the fixed frame assembly (12).

1. A rock and root puller connected to a three point hitch assembly and used for extracting rocks, stumps roots and other impediments at or below ground level having the following improvement:
a fixed frame assembly and an articualted frame assembly both bivotally connected together and said articulated frame assembly moving along a vertical plane relative to said fixed frame assembly when actuated by a hydraulic piston;
a set of braces bracing both ends of said piston and forming a piston frame assembly;
a three point hitch brace securing said three point hitch assembly;
a straight edge situated underneath said articulated frame assembly.

2. A rock and root puller as in claim 1 wherein:
Said straight edge being braced by a straight edge brace.

3. A rock and root puller as in claim 1 wherein:
Said straight edge further terminating at its lowest end by a claw

4. A rock and root puller as in claim 3 wherein:
said claw having a beveled tip;

5. A rock and root puller as in claim 1 wherein:
underneath said fixed frame assembly is a pair of extendable stands set proximal to the three point hitch assembly, which keep said rock and root puller upright and help in mounting and dismounting.

6. A rock and root puller as in claim 1 wherein:
Reinforcement braces for adding strength to said rock and root puller.

7. A rock and root puller as in claim 1 wherein:
Stand holders to secure said stands onto said fixed frame assembly.
